(19) United States
(12) Patent Application Publication
(10) Pub. No.: US 2005/0217483 A1
(43) Pub. Date: Oct. 6, 2005

(54) Ingredient and process for producing copper (I) chloride, adsorbent and adsorbing method for reductive gas each with the use of copper (I) chloride, and recovering method of carbon monoxide gas

(76) Inventors: Takashi Shimada, Kanagawa (JP); Koshi Ochi, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/095,577

(22) Filed: Apr. 1, 2005

(30) Foreign Application Priority Data
Apr. 2, 2004 (JP) 2004-109590

(51) Int. Cl. B01D 53/02

(52) U.S. Cl. 95/140; 423/491

(57) ABSTRACT

An ingredient for producing copper (I) chloride obtained by mixing copper (II) chloride and copper (II) carboxylate. A production process of copper (I) chloride comprising the steps of mixing copper (II) chloride and copper (II) carboxylate and heat-treating the resultant mixture under a reduced pressure, under the atmosphere of an inert gas, or under the atmosphere of a reductive gas. An absorbent for at least one reductive gas selected from carbon monoxide gas, ethylene gas or acetylene gas, which is obtained by supporting copper (II) chloride and copper (II) carboxylate on a carrier and by heat-treating the resultant carrier under a reduced pressure, under the atmosphere of an inert gas, or under the atmosphere of a reductive gas. A recovering method of carbon monoxide gas, wherein a gas containing carbon monoxide is brought into contact with an absorbent which is obtained by supporting copper (II) chloride and copper (II) carboxylate on a carrier and by heat-treating the resultant carrier under a reduced pressure, under the atmosphere of an inert gas, or under the atmosphere of a reductive gas, thereafter recovering carbon monoxide gas by desorbing it from the absorbent by heat-treatment and/or pressure reduction. The ingredient for producing copper (I) chloride of the present invention can be prepared without using any special manufacturing facilities or instruments under the atmosphere of the air, and at the same time, it can be stored under the atmosphere of the air without changing in quality for a long term. Moreover, the adsorbent of reductive gas in accordance with the present invention can adsorb carbon monoxide gas again soon after desorbing carbon monoxide gas without particularly treating it.

### TECHNICAL FIELD

The present invention relates to an ingredient and process for producing copper (I) chloride. The present invention further relates to an adsorbent and an adsorbing method for reductive gases each with the use of copper (I) chloride. Still further, the present invention relates to a recovering method of carbon monoxide gas.

### BACKGROUND ART

Conventionally, copper (I) chloride for industrial use is produced, for example, by heating and bringing an aqueous solution of copper (II) sulfate and sodium chloride into contact with sulfur dioxide, or by adding hydrochloric acid to a mixture of copper (II) chloride and copper tips (copper powder), followed by heating. Further, it is well known that hydrochloric acid solution of copper (I) chloride absorbs carbon monoxide resultantly generating CuCl.CO.H₂O and that an adsorbent or an recovering agent for carbon monoxide made by supporting the compound on a carrier or so is utilized. For example, Japanese Unexamined Patent Application Laid Open No. Show 61-97121 discloses an absorbent made by dissolving a complex of copper (I) chloride and aluminum halide (III) in hydrochloric acid solvent, in organic solvent or so and supporting on a carrier of activated carbon and so on; Japanese Unexamined Patent Application Laid-Open No. Hei 9-290149 discloses a carbon monoxide adsorbing agent constituted from a composite that supports a complex formed from pyridine or its derivative and copper halide on silica gel; or Japanese Unexamined Patent Application Laid-Open No. Hei 9-290152 discloses a carbon monoxide adsorbing agent constituted from a composite body produced by depositing a binary complex consisting of a diamine compound having the defined chemical formula and a copper (I) halide on a silica gel.

It is considered that these adsorbent raises activity for adsorbing carbon monoxide by forming a complex of copper chloride. Additionally, copper (I) chloride is employed as the adsorbent of ethylene or acetylene as disclosed in Japanese Unexamined Patent Application Laid-Open No. Hei 1-39938; employed as an organic synthesized catalyst in manufacturing of carbonic acid alkyl as disclosed in Japanese Unexamined Patent Application Laid-Open No. Hei 5-194327; or employed as an organic synthesized catalyst in manufacturing of carbonic acid ester as disclosed in Japanese Unexamined Patent Application Laid-Open No. Hei 6-25105.

However, copper (I) chloride has a disadvantage that it is apt to be oxidized in the air and transferred into copper (II) chloride easily. Accordingly, the production and the storage of copper (I) chloride were carried out under the atmosphere of an inert gas. Further, in the case where copper (I) chloride is employed as an adsorbent for adsorbing carbon monoxide gas contained in gases, for example, copper (I) chloride was filled in a adsorption column while feeding the inert gas into the adsorption column. Under these circumstances, Japanese Unexamined Patent Application Laid-Open No. Hei 11-226389 discloses the development of the adsorbent, for example, being not easily oxidized, which is made by supporting the mixture of copper (I) chloride, an iron compound, a manganese compound and a tin compound on the carrier of activated carbon.

However, it was necessary for the production of copper (I) chloride with the use of hydrochloric acid solution or for the adsorbent made by supporting the dissolved copper (I) chloride in hydrochloric acid solvent on the carrier that production facilities, a filling container and so on should be made of a corrosion resistant material. Further, it was necessary for the adsorbent made by supporting the dissolved copper (I) chloride in an organic solvent on the carrier to provide facilities to recover the organic solvent in a drying step of the adsorbent. Additionally, copper (I) chloride hardly dissolves in water, and although copper (II) chloride dissolves in water to some extent, it has disadvantages that hydrogen chloride generates in an occasion of being reduced to copper (I) chloride by an activation treatment under the atmosphere of the inert gas or the reductive gas, and that the adsorption capability (absorbed amount of the gas per adsorbent) is poor.

Moreover, copper (I) chloride generally has a drawback that its adsorption capability for carbon monoxide is relatively poor although it is mixed with any compound conventionally employed and although it is supported on the carrier. Still further, copper (I) chloride has a disadvantage that its adsorption capability decreases with a lapse of time after the production unless it is stored under the atmosphere of the inert gas or so because it is gradually oxidized under the existence of oxygen. In this regard, a production of copper (I) chloride just before using it for adsorption of carbon monoxide gas, ethylene gas or acetylene gas, or organic synthesis in order to evade from long term storage for the purpose of preventing progress of oxidation of copper (I) chloride may be considered, however, there are disadvantages that vacuum drying is necessary requiring times and troubles and that large amounts of copper (I) chloride cannot be manufactured at a time despite using facilities of comparatively large scale.

### SUMMARY OF INVENTION

Accordingly, an object of the present invention is to provide means for easily producing large amounts of copper (I) chloride when it is necessary without using corrosion resistant production facilities or using facilities for recovering organic solvent, to provide an adsorbent for efficiently adsorbing carbon monoxide gas, ethylene gas or acetylene gas abundantly, and recovery means for easily recovering carbon monoxide gas, which efficiently desorbs carbon monoxide gas from the adsorbent.

As a result of extensive researches for overcoming the foregoing problems by the inventors, it was found that a mixture of copper (II) chloride and copper (II) carboxylate easily generates copper (I) chloride after heat-treatment under the atmosphere of an inert gas or a reductive gas, that the mixture is storable under the atmosphere of the air for a long term without changing its quality, that the mixture is easily supported on a carrier and easily dried under the atmosphere of the air, that after heat-treatment on the mixture under the atmosphere of an inert gas or a reductive gas, an adsorbent having excellent adsorbing capability easily adsorbing carbon monoxide gas, ethylene gas or acetylene gas can be obtained, and that the adsorbent after adsorbing carbon monoxide gas easily desorbs carbon monoxide gas by heating or vacuuming. Therefore, an ingredient and process for producing copper (I) chloride, an adsorbent and an adsorbing method for reductive gases each with the use of copper (I) chloride and a recovering method of carbon monoxide gas were completed and the object of the present invention was achieved.

The present invention provides an ingredient for producing copper (I) chloride obtained by mixing copper (II) chloride and copper (II) carboxylate.

Further, the present invention provides a production process of copper (I) chloride comprising the steps of mixing copper (II) chloride and copper (II) carboxylate; and heat-treating the resultant mixture under a reduced pressure, under the atmosphere of an inert gas, or under the atmosphere of a reductive gas.

Furthermore, the present invention provides an absorbent for at least one reductive gas selected from carbon monoxide gas, ethylene gas or acetylene gas, which is obtained by supporting copper (II) chloride and copper (II) carboxylate on a carrier and by heat-treating the resultant carrier under a reduced pressure, under the atmosphere of an inert gas, or under the atmosphere of a reductive gas.

Still further, the present invention provides an adsorbing method of at least one reductive gas selected from carbon monoxide gas, ethylene gas or acetylene gas, wherein a gas containing the reductive gas selected from carbon monoxide gas, ethylene gas or acetylene gas is brought into contact with an adsorbent which is obtained by supporting copper (II) chloride and copper (II) carboxylate on a carrier and by heat-treating the resultant mixture on the carrier under a reduced pressure, under the atmosphere of an inert gas, or under the atmosphere of a reductive gas.

Still further, the present invention provides a recovering method of carbon monoxide gas, wherein a gas containing carbon monoxide is brought into contact with an absorbent which is obtained by supporting copper (II) chloride and copper (II) carboxylate on a carrier and by heat-treating the resultant mixture on the carrier under a reduced pressure, under the atmosphere of an inert gas, or under the atmosphere of a reductive gas, thereafter recovering carbon monoxide gas by desorbing it from the absorbent by heat-treatment and/or pressure reduction.

### BRIEF DESCRIPTION OF THE DRAWINGS

FIG. 1 illustrates a system for carrying out the process for producing copper (I) chloride, adsorption method of reductive gas and recovering method of carbon monoxide gas in accordance with the present invention;

FIG. 2 illustrates another system for carrying out the process for producing copper (I) chloride, adsorption method of reductive gas and recovering method of carbon monoxide gas in accordance with the present invention; and

FIG. 3 illustrates a block-diagram of an apparatus for carrying out tests for evaluating the adsorbent, the adsorbing method and the recovering method each in accordance with the present invention.

### DESCRIPTION OF THE PREFERRED EMBODIMENTS

The ingredient and process for producing copper (I) chloride of the present invention are applied to a production material and a production method of an adsorbent of carbon monoxide gas, ethylene gas or acetylene gas, and applied to a production material and a production method of an organic synthesized catalyst.

Further, the adsorbent, the adsorbing method and the recovering method of a reductive gas in accordance with the present invention are applied for adsorption of carbon monoxide gas, ethylene gas or acetylene gas contained in a base gas including hydrogen, nitrogen, argon, helium, carbon dioxide, methane and so on, or applied for recovery of carbon monoxide gas.

The copper (II) carboxylate employed as the ingredient for production of copper (I) chloride in the present invention is a compound represented by general formula: (RCOO)₂Cu (R: hydrogen or alkyl group), and either copper (II) formate or copper (II) acetate is preferable in a viewpoint of easily available. Although it is possible to store copper (II) chloride and copper (II) carboxylate after merely mixing, to dissolve the mixture of copper (II) chloride and copper (II) carboxylate in a solvent such as water, alcohol or so and to support it on a carrier such as activated carbon, ceramics, synthetic zeolite, synthetic resin or so may be employable for use or storage. Additionally, in the case where the carrier is used, activated carbon is preferable as the carrier being prepared not only as granular or as cracked state but also as activated carbon fibers.

In the present invention, although both copper (II) chloride and copper (II) carboxylate commercially available in the market may be employable as the ingredient for producing copper (I) chloride, they may be prepared by dissolving copper (II) oxide, copper (II) hydroxide or basic copper (II) carbonate each in hydrochloric acid or carboxylic acid respectively. The mixing ratio of copper (II) chloride and copper (II) carboxylate is usually 1:0.1 to 10, preferably 1:0.2 to 5.

The ingredient for producing copper (I) chloride of the present invention may contain moisture. Further, although it may contain impurities, inactive substances, binders without adverse effects against the purpose of usage, the contents of copper (II) chloride and copper (II) carboxylate to entire ingredients except the carrier is usually at least 50% by weight and preferably at least 90% by weight.

Further, in the case where the carrier is used for supporting the ingredients, the contents of copper (II) chloride and copper (II) carboxylate in the entire ingredient including the carrier is usually at least 10% by weight and preferably at least 20% by weight.

The ingredient of the present invention can be molded, for example, by extrusion molding method or compression formation method, and although its configuration or its size is not specified, when it is spherical, the diameter is usually about 1 to 10 mm, and when it is cylindrical, the diameter is usually about 1 to 5 mm, and the height is usually about 2 to 20 mm, or other resembling configuration and corresponding size may be employed in the preparation. Moreover, even in the case where the carrier is used, neither the configuration of the carrier nor the size of the carrier is specified and the above configuration and the above size may be employed in the preparation.

Copper (I) chloride of the present invention is produced by heat-treating the foregoing ingredient under the reduced pressure, under the atmosphere of an inert gas or under the atmosphere of a reductive gas. Typical examples of the inert gas include nitrogen gas, argon gas, helium gas, etc. Typical examples of the reductive gas include hydrogen gas, carbon monoxide gas, ether gas, alcohol gas, ketone gas, ester gas, hydrocarbon gas, etc. In the occasion of the heat treatment, the temperature is usually 80 to 350° C. When the heat-treatment is conducted under the atmosphere of the inert gas or under the atmosphere of the reductive gas, the pressure is not particularly specified, however, it is usually 0.05 to 1200 kPa.

The adsorbent of reductive gas of the present invention is obtained by supporting the foregoing copper (II) chloride and copper (II) carboxylate on a carrier and by heat-treating the resultant carrier under a reduced pressure, under the atmosphere of an inert gas, or under the atmosphere of a reductive gas. The inert gas or the reductive gas each to be employed is the same as the foregoing description. Further, the temperature and the pressure of the heat-treatment are also similar as the foregoing description.

Additionally, in the occasion of the heat-treatment to the mixture of copper (II) chloride and copper (II) formate, for example, it is considered that the following chemical reaction predominantly occurs:
CuCl₂+(HCOO)₂Cu→2CuCl+H₂O+CO₂+CO

The reason why the adsorbent of a reductive gas of the present invention is capable of adsorbing carbon monoxide gas, ethylene gas or acetylene gas in large amount and excellent in adsorbing capability is considered to be that the ingredient for producing copper (I) chloride of the present invention is possible to increase the supported amount on the carrier because it is hardly crystallized forming starch syrup during being dried. Another reason is considered to be that, after the addition, the surface area of the absorbent increases because a reduction of carboxylic acid by thermal decomposition occurs and cavities caused by defect of carboxylic acid generate. With this regard, the adsorbent of reductive gas in the present invention is substantially different and exhibits extremely superior adsorbing capability than an absorbent made by supporting copper (I) chloride alone on the carrier, made by supporting copper (II) chloride alone on the carrier or made by supporting copper (II) carboxylate alone on the carrier. Moreover, it never induces hydrogen chloride, which will generate in a heat-treatment on copper (II) chloride alone. Further, it is recognized that the crystal structure of copper (I) chloride in accordance with the present invention includes Nantokite structure (natural CuCl).

The present invention provides an adsorbing method of at least one reductive gas selected from carbon monoxide gas, ethylene gas or acetylene gas, which adsorbs carbon monoxide gas, ethylene gas or acetylene gas onto the foregoing adsorbent while bringing it into contact with each other, however, it is usually carried out by heat-treating the ingredient for producing copper (I) chloride under a reduced pressure, under the atmosphere of an inert gas, or under the atmosphere of a reductive gas. Namely, after preparing the adsorbent containing copper (I) chloride by filling the ingredient for producing it obtained by supporting copper (II) chloride and copper (II) carboxylate on a carrier into an adsorption column and by heat-treating it under the atmosphere of an inert gas or under the atmosphere of a reductive gas, the adsorbing method is carried out by advancing the gas containing the reductive gas selected from carbon monoxide gas, ethylene gas or acetylene gas through the adsorption column.

The filling length of the adsorbent which is filled into the adsorption column may be appropriately designed without particular restriction depending on the application, a flow rate of the reductive gas to be adsorbed, etc. Regarding with a superficial linear velocity of the reductive gas which flows through the adsorption column, it is not generally specified because it depends on the concentration of carbon monoxide gas, ethylene gas or acetylene gas and on the prescription of the adsorbent, however, it is usually up to 100 cm/sec, and is preferably up to 30 cm/sec.

In the occasion of adsorbing carbon monoxide gas, ethylene gas or acetylene gas onto the adsorbent, the temperature is usually 0 to 150° C., and the pressure is usually 0.05 to 1200 kPa.

The present invention provides a recovering method of carbon monoxide gas that recovers it by desorbing carbon monoxide gas from the foregoing adsorbent that adsorbed carbon monoxide gas. The desorption of carbon monoxide gas is conducted by carrying out at least one of heating the adsorption column or pressure reduction of the adsorption column. However, heating the adsorption column is to elevate the temperature of the column higher than the temperature at the time of the adsorption, and pressure reduction of the adsorption column is to decrease the pressure of the adsorption column lower than the pressure of the adsorption column at the time of the adsorption. Accordingly, they do not necessarily mean heating the adsorption column to the temperature higher than the ordinary temperature or reducing the pressure of the adsorption column to the pressure lower than the ordinary pressure. When the desorption of carbon monoxide gas is conducted only by heating, the temperature is usually 30 to 350° C., and when the desorption of carbon monoxide gas is conducted only by pressure reduction, the pressure is usually 0.1 to 100 kPa.

Carbon monoxide gas desorbed from the adsorbent in accordance with the present invention may be reused without any treatment and may be stored as gas or after liquefication. Additionally, after desorbing carbon monoxide gas from the adsorbent, the adsorbent in accordance with the present invention can adsorb carbon monoxide gas again without particularly treating it. Further, even repetitions of adsorption and desorption only slightly deteriorate the adsorbing capability of the adherent. Furthermore, although contacting with the air may deactivate the adsorbent in accordance with the present invention, it may be reproduced by the heat-treatment again under the atmosphere of a reductive gas.

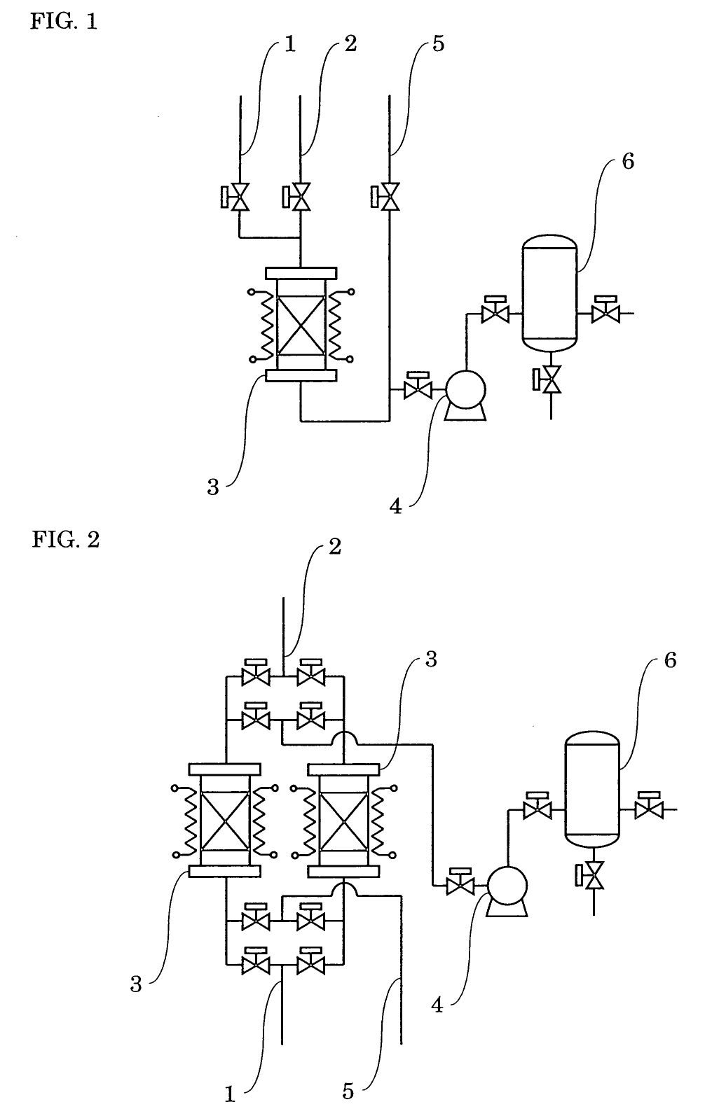

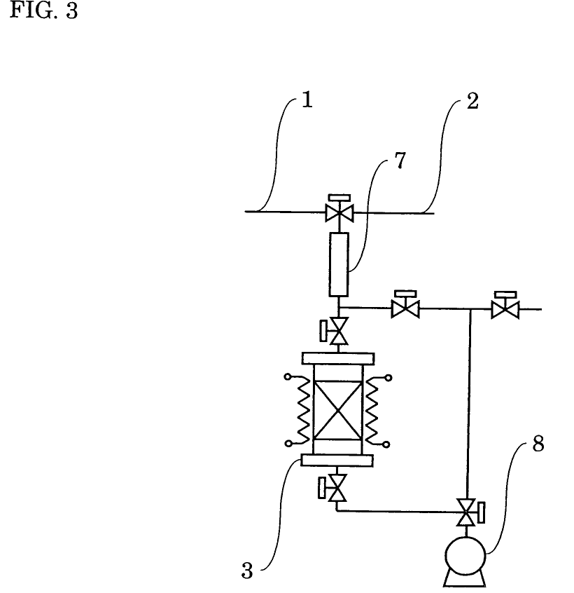

FIGS. 1 and 2 illustrate systems for carrying out the process for producing copper (I) chloride, adsorption method of reductive gas and recovering method of carbon monoxide gas in accordance with the present invention. The system comprises a feed pipe 1 for feeding an inert gas or a reductive gas, a feed pipe 2 for feeding a gas containing at least one reductive gas selected from carbon monoxide gas, ethylene gas or acetylene gas, an adsorption column 3, a blower 4, a gas exhaust pipe 5 and a storage tank 6 for storing the recovered carbon monoxide gas.

In the system of FIG. 1, an ingredient for producing copper (I) chloride obtained by supporting copper (II) chloride and copper (II) carboxylate on a carrier is filled into the adsorption column 3. Subsequently, by heating the adsorption column 3, and by simultaneously feeding an inert gas or a reductive gas through the feed pipe 1 into the adsorption column 3, copper (I) chloride is prepared.

In the system of FIG. 1, adsorption of a reductive gas is carried out by feeding a gas containing the reductive gas selected from carbon monoxide gas, ethylene gas or acetylene gas through the feed pipe 2 into the adsorption column 3. Further, the recovering of carbon monoxide gas is carried out by heating and/or pressure reduction of inside of the adsorption column, simultaneously operating the blower 4. Additionally, as shown in FIG. 2, connecting two adsorption columns in parallel, then, by adsorbing carbon monoxide gas using one adsorption column and simultaneously desorbing carbon monoxide gas using another adsorption column enables to efficiently recover carbon monoxide gas.

In the following examples are described several preferred embodiments to concretely illustrate the invention, however, it is to be understood that the invention is not intended to be limited to the specific embodiments.

### EXAMPLES

### Example 1

(Preparation of the Ingredient for Producing Copper (I) Chloride)

Commercially available copper (II) formate (purity: 99.9%) in the market and commercially available copper (II) chloride (purity: 99.9%) in the market were mixed in a manner that the ratio of their molecule number corresponds to 1:1. An aqueous solution made by dissolving the mixture in an amount of 120 g into 80 milliliter of water was sprayed over 100 g of activated carbon and impregnated into it, and then, an ingredient for producing copper (I) chloride was prepared by drying them under the atmosphere of the air at the temperature of 60° C. for 4 hours.

(Preparation of Copper (I) Chloride)

The ingredient thus obtained for producing copper (I) chloride was filled into an adsorption column (with an inside diameter of 20 mm and with a height of 110 mm) of an experimental device having a mass flow controller 7 and a vacuum pump 8 as shown in FIG. 3 in a manner that the filling length became 100 mm, then, it was heat-treated under the atmosphere of nitrogen gas at the temperature of 120° C. for 3 hours, resulting in preparation of copper (I) chloride. Further, it was confirmed that any hydrogen chloride gas never generated during the heat-treatment.

(Adsorption Test of Carbon Monoxide Gas)

Closing an inlet valve of the adsorption column, operating the vacuum pump, and after opening an outlet valve, the gas adsorbed by the adsorbent was desorbed, and then, by closing the outlet valve and by separating the adsorption column, the adsorption column was weighed. Subsequently, after connecting the adsorption column with a pipe and filling the pipe of the inlet side of the adsorption column with carbon monoxide gas, opening the inlet valve of the adsorption column, and feeding carbon monoxide gas having concentration of 100% into the adsorption column at the temperature of 25° C. and under the pressure of 100 k Pa, closing the inlet valve in the timing that the flow rate of carbon monoxide gas became zero, and then separated the adsorption column and weighed the adsorption column. Pursuing an absorbed amount of carbon monoxide gas from weight variation of the adsorption column, an adsorption capability of carbon monoxide gas per adsorbent (L/L agent) was calculated. The results are shown in Table 1.

(Desorption Test of Carbon Monoxide Gas)

Then, after starting the vacuum pump to operate, opening the outlet valve, desorbed carbon monoxide gas that was adsorbed to the adsorbent, subsequently closing the outlet valve of the adsorption column, separated the adsorption column, and weighed the adsorption column. Pursuing a desorbed amount of carbon monoxide gas from weight variation of the adsorption column, a desorbing volume of carbon monoxide gas per adsorbent (L/L agent) was calculated. The results are shown in Table 2.

(Repetition Test of Adsorption and Desorption of Carbon Monoxide Gas)

Subsequently, the foregoing adsorption test and desorption test of carbon monoxide gas were repeated nine times. The results are shown in Table 1 and Table 2.

### Example 2

An ingredient for producing copper (I) chloride was prepared in a similar manner as Example 1, except that the mixing of copper (II) formate and copper (II) chloride is carried out such that the ratio of each molecule number became 0.5:1. The repetition test of adsorption and desorption of carbon monoxide gas was conducted after preparing copper (I) chloride in a similar manner as Example 1 except that the above ingredient was employed. The results are shown in Table 1 and Table 2.

### Example 3

An ingredient for producing copper (I) chloride was prepared in a similar manner as Example 1, except that the mixing of copper (II) formate and copper (II) chloride is carried out such that the ratio of each molecule number became 0.8:1. The repetition test of adsorption and desorption of carbon monoxide gas was conducted after preparing copper (I) chloride in a similar manner as Example 1 except that the above ingredient was employed. The results are shown in Table 1 and Table 2.

### Example 4

An ingredient for producing copper (I) chloride was prepared in a similar manner as Example 1, except that the mixing of copper (II) formate and copper (II) chloride is carried out such that the ratio of each molecule number became 1.2:1. The repetition test of adsorption and desorption of carbon monoxide gas was conducted after preparing copper (I) chloride in a similar manner as Example 1 except that the above ingredient was employed. The results are shown in Table 1 and Table 2.

### Example 5

An ingredient for producing copper (I) chloride was prepared in a similar manner as Example 1, except that the mixing of copper (II) formate and copper (II) chloride is carried out such that the ratio of each molecule number became 1.5:1. The repetition test of adsorption and desorption of carbon monoxide gas was conducted after preparing copper (I) chloride in a similar manner as Example 1 except that the above ingredient was employed. The results are shown in Table 1 and Table 2.

### Example 6

An ingredient for producing copper (I) chloride was prepared in a similar manner as Example 1 except that copper (II) formate was replaced by copper (II) acetate. The repetition test of adsorption and desorption of carbon monoxide gas was conducted after preparing copper (I) chloride in a similar manner as Example 1 except that the above ingredient was employed. The results are shown in Table 1 and Table 2.

### Example 7

The test of adsorption and desorption of carbon monoxide gas was conducted in the same manner as Example 1 after preparing copper (I) chloride in the same manner as Example 1. Then, after deactivating the adsorbent by bringing it into contact with the air, the test of adsorption and desorption of carbon monoxide gas was conducted. Further, after re-activating the adsorbent by heat-treating it under the atmosphere of the carbon monoxide gas at the temperature of 160° C. for 2 hours, the test of adsorption and desorption of carbon monoxide gas was conducted. The results are shown in Table 3.

### Comparative Example 1

The repetition test of adsorption and desorption of carbon monoxide gas was conducted in the same manner as Example 1 except that only the activated carbon used as the carrier in the preparation of the ingredient for producing copper (I) chloride in Example 1 was employed alone as the adsorbent. Additionally, the activated carbon was dried under pressure reduction at the temperature of 120° C. for 3 hours beforehand. The results are shown in Table 1 and Table 2.

### Comparative Example 2

Purified copper (I) chloride in an amount of 10 g was dissolved in 200 milliliter of acetonitrile and the solution was sprayed over 70 g of the activated carbon under the atmosphere of nitrogen gas, and after the solution was impregnated into the activated carbon, an adsorbent was prepared by drying the resultant activated carbon under vacuum pressure reduction at the temperature of 60° C. for 3 hours. Additionally, purified copper (I) chloride was prepared by dripping an aqueous solution obtained by dissolving commercially available copper (I) chloride (purity: 99.9%) in concentrated hydrochloric acid into ultra pure water, and by washing the precipitation of copper (I) chloride with ethanol followed by vacuum drying for 10 hours. The repetition test of adsorption and desorption of carbon monoxide gas was conducted after preparing copper (I) chloride in a similar manner as Example 1 except that the above ingredient was employed. The results are shown in Table 1 and Table 2.

### Comparative Example 3

An ingredient for producing copper (I) chloride was prepared in a similar manner as Example 1 except that copper (II) formate was not employed. The repetition test of adsorption and desorption of carbon monoxide gas was conducted after preparing copper (I) chloride in a similar manner as Example 1 by heat-treating the above ingredient under the atmosphere of the carbon monoxide gas at the temperature of 160° C. for 3 hours. The results are shown in Table 1 and Table 2. Further, a generation of hydrogen chloride gas during the heat-treatment of the ingredient was recognized.

### Comparative Example 4

An ingredient for producing copper (I) chloride was prepared in a similar manner as Example 1 except that copper (II) formate was not used and water was replaced by an aqueous solution of formic acid in the preparation of ingredient for producing copper (I) chloride in Example 1. The repetition test of adsorption and desorption of carbon monoxide gas was conducted in the same manner as Example 1 after preparing copper (I) chloride in the same manner as Comparative Example 3. The results are shown in Table 1 and Table 2. Further, a generation of hydrogen chloride gas during the heat-treatment of the ingredient was recognized.

In Tables 1 to 3, “Ex.”, “Co. Ex.”, “Cu (II) Cl”, “Cu (II) COOH”, “Actv C”, “Cu (II) acet”, “Cu (I) Cl”, “Sol.” and “COOH” are each abbreviation of “Example”, “Comparative Example”, “Copper (II) Chloride”, “Copper (II) Formate”, “Activated Carbon”, “Copper (II) Acetate”, “Copper (I) Chloride”, “Solution” and “Formic Acid” respectively. In Tables 1 and 2, “Mole No. Ratio” is an abbreviation of “Molecule Number Ratio”, which is defined as (Molecule number of Copper (II) Carboxylate)/Molecule number of Copper (II) Chloride). In Table 3, “Bef.”, “Aft.”, “Dactv” and “Recv.” are each abbreviation of “Before”, “After”, “Deactivation” and “Recovery” respectively.

TABLE 1

| | | | Adsorbing Capability | | | | |
|---|---|---|---|---|---|---|---|
| | Ingredient for Producing | Mole No. | of Adsorbent (L/L Agent) | | | | |
| | Copper Chloride (I) | Ratio | First | Second | Third | Fifth | Tenth |
| Ex. 1 | Cu (II) Cl, Cu (II) COOH/Actv C | 1.0 | 58.0 | 45.2 | 45.3 | 45.2 | 45.2 |
| Ex. 2 | Cu (II) Cl, Cu (II) COOH/Actv C | 0.5 | 48.3 | 40.5 | 40.6 | 40.4 | 40.5 |
| Ex. 3 | Cu (II) Cl, Cu (II) COOH/Actv C | 0.8 | 51.2 | 38.8 | 38.7 | 38.8 | 38.9 |
| Ex. 4 | Cu (II) Cl, Cu (II) COOH/Actv C | 1.2 | 44.8 | 34.0 | 34.2 | 34.1 | 34.3 |
| Ex. 5 | Cu (II) Cl, Cu (II) COOH/Actv C | 1.5 | 34.8 | 26.4 | 26.3 | 26.2 | 26.3 |
| Ex. 6 | Cu (II) Cl, Cu (II) Acet/Actv C | 1.0 | 30.2 | 20.6 | 20.5 | 20.5 | 20.6 |
| Co. Ex. 1 | Actv C | — | 5.2 | 3.2 | 3.2 | 3.0 | 3.1 |
| Co. Ex. 2 | Cu (I) Cl/Actv C | — | 3.6 | 2.1 | 2.3 | 2.3 | 1.9 |
| Co. Ex. 3 | Cu (II) Cl/Actv C (Sol.: H₂O) | — | 14.0 | 8.8 | 8.8 | 8.9 | 8.8 |
| Co. Ex. 4 | Cu (II) Cl/Actv C (So.l: COOH) | — | 19.2 | 12.4 | 12.3 | 12.5 | 12.5 |

TABLE 2

| | | Mole | Desorbing Volume of | | | | |
|---|---|---|---|---|---|---|---|
| | Ingredient for Producing | No. | CO gas (L/L Agent) | | | | |
| | Copper Chloride (I) | Ratio | First | Second | Third | Fifth | Tenth |
| Ex. 1 | Cu (II) Cl, Cu (II) COOH/Actv C | 1.0 | 45.1 | 45.2 | 45.2 | 45.3 | 45.2 |
| Ex. 2 | Cu (II) Cl, Cu (II) COOH/Actv C | 0.5 | 40.5 | 40.6 | 40.5 | 40.4 | 40.4 |
| Ex. 3 | Cu (II) Cl, Cu (II) COOH/Actv C | 0.8 | 38.8 | 38.7 | 38.8 | 38.7 | 38.9 |
| Ex. 4 | Cu (II) Cl, Cu (II) COOH/Actv C | 1.2 | 34.0 | 34.2 | 34.2 | 34.1 | 34.2 |
| Ex. 5 | Cu (II) Cl, Cu (II) COOH/Actv C | 1.5 | 26.3 | 26.3 | 26.2 | 26.3 | 26.2 |
| Ex. 6 | Cu (II) Cl, Cu (II) Acet/Actv C | 1.0 | 20.6 | 20.5 | 20.5 | 20.6 | 20.6 |
| Co. Ex. 1 | Actv C | — | 3.2 | 3.1 | 3.3 | 3.1 | 3.0 |
| Co. Ex. 2 | Cu (I) Cl/Actv C | — | 2.1 | 2.1 | 2.2 | 2.2 | 2.3 |
| Co. Ex. 3 | Cu (II) Cl/Actv C (Sol.: H₂O) | — | 9.0 | 8.8 | 8.9 | 8.8 | 8.8 |
| Co. Ex. 4 | Cu (II) Cl/Actv C (Sol.: COOH) | — | 12.3 | 12.4 | 12.3 | 12.4 | 12.4 |

TABLE 3

| | | Bef. Deactv | | Aft. Deactv | | Aft Recv. | |
|---|---|---|---|---|---|---|---|
| | Ingredient for Producing | (L/L Agent) | | (L/L Agent) | | (L/L Agent) | |
| | Copper Chloride (I) | Adsorption | Desorption | Adsorption | Desorption | Adsorption | Desorption |
| Ex. 7 | Cu (II) Cl, Cu (II) COOH/Actv C | 56.0 | 47.2 | 19.2 | 15.2 | 55.8 | 46.8 |

As the foregoing description, it was understood that the adsorbents consisting of copper (I) chloride prepared in accordance with the present invention in Examples 1 to 6 were, in comparison with the adsorbents consisting of copper (I) chloride prepared in accordance with the other method than the present invention in Comparative Examples 2 to 4, capable of adsorbing larger amount of carbon monoxide gas and also capable of far more efficiently desorbing carbon monoxide gas. Further, even a repetition of adsorption and desorption of carbon monoxide gas with the use of the adsorbent of the present invention does not almost decrease the adsorption capability after the second repetition. Furthermore, as reported in Example 7, although contacting with the air deactivated the adsorbent in accordance with the present invention, it was reproduced by the heat-treatment again under the atmosphere of the reductive gas.

### INDUSTRIAL APPLICABILITY

The ingredient for producing copper (I) chloride of the present invention can be prepared without using any special manufacturing facilities or instruments under the atmosphere of the air, and at the same time, it can be stored under the atmosphere of the air without changing in quality for a long term. Moreover, when it is necessary, copper (I) chloride can be produced easily and in large amount with the use of the ingredient.

The adsorbent of reductive gas in accordance with the present invention can adsorb carbon monoxide gas, acetylene gas or, ethylene gas efficiently and abundantly, while it can also desorb these reductive gases easily. Moreover, the adsorbent of reductive gas in accordance with the present invention can adsorb carbon monoxide gas again soon after desorbing carbon monoxide gas without particularly treating it. Further, even repetitions of adsorption and desorption only slightly deteriorate the adsorbing capability of the adsorbent.

While there has been shown and described what are at present considered the preferred embodiments of the invention, it will be obvious to those skilled in the art that various changes and modification may be made therein without departing from the scope of the invention defined by the appended claims.

1. An ingredient for producing copper (I) chloride obtained by mixing copper (II) chloride and copper (II) carboxylate.

2. The ingredient for producing copper (I) chloride according to claim 1, wherein the contents of both copper (II) chloride and copper (II) carboxylate in the entire ingredient are at least 50% by weight.

3. An ingredient for producing copper (I) chloride obtained by supporting copper (II) chloride and copper (II) carboxylate on a carrier.

4. The ingredient for producing copper (I) chloride according to claim 3, wherein said carrier is activated carbon, ceramics, synthetic zeolite or synthetic resin.

5. The ingredient for producing copper (I) chloride according to claim 4, wherein the contents of both copper (II) chloride and copper (II) carboxylate in the entire ingredient including the carrier are at least 10% by weight.

6. The ingredient for producing copper (I) chloride according to claim 1, wherein said copper (II) carboxylate is copper (II) formate or copper (II) acetate.

7. A production process of copper (I) chloride comprising the steps of mixing copper (II) chloride and copper (II) carboxylate; and
heat-treating the resultant mixture under a reduced pressure, under the atmosphere of an inert gas, or under the atmosphere of a reductive gas.

8. An absorbent for at least one reductive gas selected from carbon monoxide gas, ethylene gas or acetylene gas, which is obtained by supporting copper (II) chloride and copper (II) carboxylate on a carrier and by heat-treating the resultant carrier under a reduced pressure, under the atmosphere of an inert gas, or under the atmosphere of a reductive gas.

9. An adsorbing method of at least one reductive gas selected from carbon monoxide gas, ethylene gas or acetylene gas, wherein a gas containing the reductive gas selected from carbon monoxide gas, ethylene gas or acetylene gas is brought into contact with an adsorbent which is obtained by supporting copper (II) chloride and copper (II) carboxylate on a carrier and by heat-treating the resultant mixture on the carrier under a reduced pressure, under the atmosphere of an inert gas, or under the atmosphere of a reductive gas.

10. A recovering method of carbon monoxide gas, wherein a gas containing carbon monoxide gas is brought into contact with an absorbent which is obtained by supporting copper (II) chloride and copper (II) carboxylate on a carrier and by heat-treating the resultant mixture on the carrier under a reduced pressure, under the atmosphere of an inert gas, or under the atmosphere of a reductive gas, thereafter recovering carbon monoxide gas by desorbing it from the absorbent by any one selected from heat-treatment or pressure reduction.
